(19) United States
(12) Patent Application Publication
(10) Pub. No.: US 2015/0149803 A1
(43) Pub. Date: May 28, 2015

(54) ELECTRONIC DEVICE, CONTROL METHOD, AND COMPUTER-READABLE STORAGE MEDIUM

(71) Applicant: Kabushiki Kaisha Toshiba, Tokyo (JP)

(72) Inventor: Kei Takahashi, Tokyo (JP)

(21) Appl. No.: 14/468,024

(22) Filed: Aug. 25, 2014

Related U.S. Application Data
(60) Provisional application No. 61/908,950, filed on Nov. 26, 2013.

(51) Int. Cl. G06F 9/44; G06F 13/24; G06F 1/32

(52) U.S. Cl. CPC G06F 9/4418; G06F 1/3262; G06F 1/3287; G06F 13/24
USPC 713/323

(57) ABSTRACT

In an embodiment, an electronic device includes a power supply module, a processor, a mode setting module and a clock module. The processor is configured to operate with power from the power supply module, and to be able to enter a power-saving operation state. The mode setting module turns on or off a mode in which the processor is inhibited from exiting the power-saving operation state due to an interrupt. The clock module is configured to generate the interrupt, if the mode is off, when predetermined time is reached while the processor is in the power-saving operation state, and not to generate the interrupt, if the mode is on, even when the time is reached while the processor is in the power-saving operation state.

### CROSS-REFERENCE TO RELATED APPLICATIONS

This application claims the benefit of U.S. Provisional Application No. 61/908,950, filed Nov. 26, 2013, the entire contents of which are incorporated herein by reference.

### FIELD

Embodiments described herein relate generally to an electronic device, a control device for controlling the same and a computer-readable storage medium.

### BACKGROUND

Electronic devices are present which have a function of entering a power-saving operation state, such as suspend or hibernation.

There is a case where even after entering a power-saving operation state, an electronic device resumes operation in order to execute predetermined processing. Such a resuming operation is achieved with an interrupt function of, e.g., a real time clock (RTC). The interrupt function is referred to as an RTC wake-up or an RTC alarm. Also, there is a case where after entering the power-saving operation state, the electronic device resumes operation in response to a command externally transmitted.

The above resume operation consumes power even when the electronic device is in the power-saving operation state.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view of an appearance of an electronic device according to an embodiment;

FIG. 2 is a block diagram of a hardware structure of the electronic device according to the embodiment;

FIG. 3 is a block diagram of functions to be performed by the electronic device according to the embodiment;

FIG. 4 is a flowchart of operations to be performed until the electronic device according to the embodiment enters a power-saving operation state; and

FIG. 5 is a flowchart of operations to be performed in the case where the electronic device according to the embodiment is in the power-saving operation state and exits the power-saving operation state.

### DETAILED DESCRIPTION

Various embodiments will be described hereinafter with reference to the accompanying drawings.

In general, according to one embodiment, an electronic device includes a power supply module, a processor, a mode setting module and a clock module. The power supply module is configured to supply power. The processor is configured to operate with the power from the power supply module, and to be able to enter a power-saving operation state in which the consumption of the power is lower than that in a regular operation state. The mode setting module is configured to turn on or off a mode for inhibiting the processor from exiting the power-saving operation state due to an interrupt. The clock module is configured to generate the interrupt, if the mode is off, when predetermined time is reached while the processor is in the power-saving operation state, and not to generate the interrupt, if the mode is on, even when the time is reached while the processor is in the power-saving operation state.

A detailed explanation will be given with respect to the electronic device according to an embodiment. It will be with respect to the case where the electronic device according to the embodiment is a tablet computer.

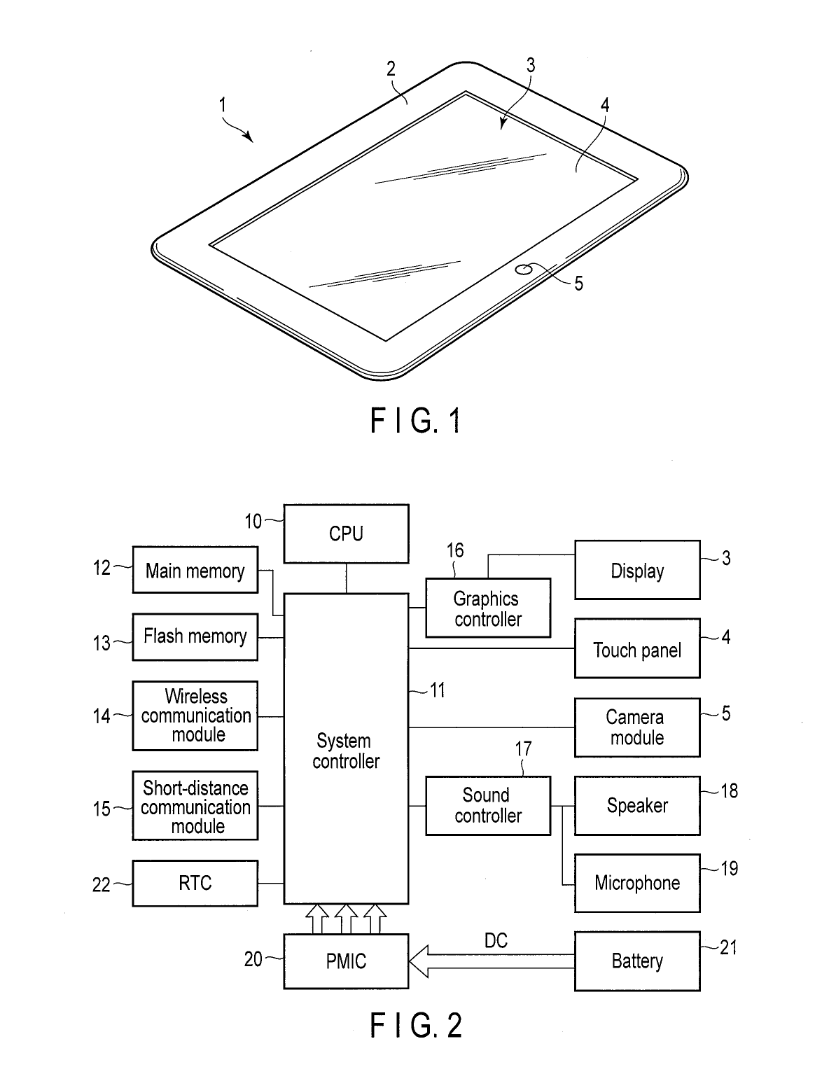

FIG. 1 is a perspective view of an appearance of a tablet computer 1 according to the embodiment. The tablet computer 1 includes a housing 2, a display 3, a touch panel 4 serving as an operation module, and a camera module 5.

The housing 2 is formed in the shape of a thin box. The display 3 has a rectangular display area, and is provided such that the display area is exposed at a surface of the housing 2. As the display 3, for example, a flat panel type of liquid crystal display (LCD) can be applied.

The touch panel 4 is stacked on an upper surface of an upper surface of the display 3, and detects the position of a pen or a finger of a user which contacts the display area. As the touch panel 4, for example, a capacitance type of touch panel can be applied. Instead of the touch panel 4 or along with the touch panel 4, for example, an electromagnetic induction type of digitizer may be provided at the tablet computer 1.

The camera module 5 includes, e.g., a charge coupled device (CCD) sensor, which produces image data on an imaging area.

FIG. 2 is a block diagram of a hardware structure of the tablet computer 1. In addition to elements as shown in FIG. 1, the tablet computer 1 includes a central processing unit (CPU) 10, a system controller 11, a main memory 12, a flash memory 13, a wireless communication module 14, a short-distance communication module 15, a graphics controller 16, a sound controller 17, a speaker 18, a microphone 19, a power management IC (PMIC) 20 serving as a power supply module, a battery 21 and an RTC 22 serving as a clock module.

The CPU 10 is a processor configured to control operations of various modules in the tablet computer 1. The main memory 12 is, e.g., a double-data-rate (DDR) SDRAM. The flash memory 13 is, e.g., a NAND type flash memory, and stores an operating system (OS), data and computer programs regarding various applications, etc. The CPU 10 loads a computer program stored in the flash memory 13 into the main memory 12, and executes processing written in the computer program.

The system controller 11 is a device connecting a local bus of the CPU 10 and various components. The system controller 11 incorporates a memory controller configured to exert an access control of the main memory 12. Also, the system controller 102 has a function of execute communication with the graphics controller 16 through a serial bus compliant with predetermined standards or the like.

The graphics controller 16 is a controller configured to control the display 3. A display signal produced by the graphics controller 16 is transmitted to the display 3. The display 3 displays an image based on the display signal.

Furthermore, the system controller 11 has a function of executing communication with the sound controller 17. The sound controller 17 outputs a signal according to audio data to be subjected to playback to the speaker 18. The speaker 18 outputs sound in accordance with the signal. The sound controller 17 performs at a predetermined sampling frequency, sampling of a sound signal produced by the microphone 19 in accordance with surrounding sound, and produces audio data.

The wireless communication module 14 executes wireless communication compliant with wireless communication standards of a wireless LAN such as Wi-Fi (registered trademark) or 3G mobile communication. The short-distance communication module 15 executes wireless communication compliant with short-distance communication standards such as Bluetooth (registered trademark).

The PMIC 20 includes, e.g., a plurality of DC-DC converters corresponding to a plurality of channels. These converters convert DC power supplied from the battery 21 into DC power having a predetermined voltage, and supply the obtained DC power to each of hardware in the tablet computer 1.

Also, the PMIC 20 has a function of causing the tablet computer 1 to enter a power-saving operation state. The power-saving operation state which the PMIC 20 can enter includes, e.g., sleep (also referred to as a standby or suspend) corresponding to S3 class defined under advanced configuration and power interface (ACPI) standards. When it enters the sleep, the CPU 10 stores in the main memory 12, data written to a register or the like of the CPU 10. Then, supplying of power to various hardware excluding at least the main memory 12 is stopped, thus reducing the power consumption of the tablet computer 1.

The RTC 22 measures time in order that the year, month, day, hour, minute and second be indicated as the time. The RTC 22 includes its exclusive battery, and can thus operate due to power supplied from the battery even if supplying of power to the tablet computer 1 is stopped.

The RTC 22 has an interrupt function of generating an interrupt for the CPU 10 when predetermined time is reached. The interrupt function is referred to as a RTC wake-up, a RTC alarm, etc.

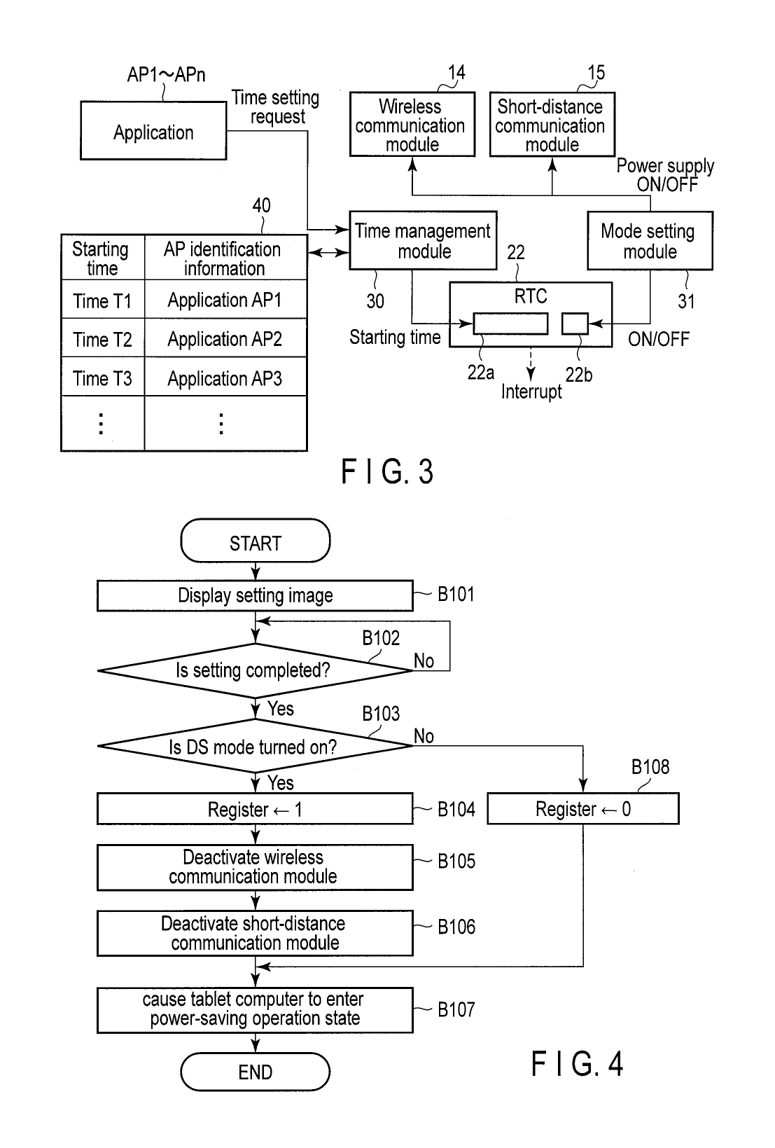

The functions which the tablet computer 1 performs will be explained with reference to FIG. 3. The explanation will be given, paying attention mainly to functions specific to the embodiment. Thus, explanations of other functions will be omitted.

As shown in FIG. 3, the RTC 22 includes registers 22a and 22b. The register 22a is a register for setting time (hereinafter referred to as starting time) in which the interrupt is to be generated. As the starting time, for example, the year, month, day, hour, minute and second are set in the register 22a. With respect to the embodiment, the following explanation is given with respect to the case where the register 22a can store data indicating a single starting time.

The register 22b is a register for making the interrupt function active or inactive. For example, the register 22b is a 1-bit register, and when its state is “0” (first identification information), the interrupt function is made active, and when its state is “1” (second identification information), the interrupt function is made inactive.

The tablet computer 1 includes a time management module 31 and a mode setting module 31. The time management module 30 and the mode setting module 31 are achieved by executing a predetermined computer program with the CPU 10. The computer program may be part of a program regarding, e.g., the OS, and the time management module 30 and the mode setting module 31 are included in the functions of OS.

The time management module 30 writes a starting time to the register 22a in accordance with, e.g., a time setting request from any of applications AP1-APn installed onto the tablet computer 1. The time setting request includes the starting time to be written to the register 22a. Furthermore, the time management module 30 writes to a management table 40, the starting time included in the time setting request and AP identification information for identifying an application which makes the time setting request. The management table 40 is stored in, e.g., the main memory 12 or the flash memory 13.

The mode setting module 31 turns on or off a deep sleep mode for inhibiting the tablet computer 1 from exiting the power-saving operation state due to an interrupt. To be more specific, the mode setting module 31 turns off the deep sleep mode by writing “0” to the register 22b, and turns on the deep sleep mode by writing “1” to the register 22b.

Also, in the case where the deep sleep mode is on, the mode setting module 31 deactivates the wireless communication module 14 and the short-distance communication module 15. The deactivation of the wireless communication module 14 and the short-distance communication module 1 means that for example, the wireless communication module 14 and the short-distance communication module 15 are made unable to receive data transmitted externally. For example, the wireless communication module 14 and the short-distance communication module 15 can be deactivated by stopping supplying of power to the entire communication modules 14 and 15 or structural elements such as antennas included in the communication modules 14 and 15. Alternatively, the communication modules 14 and 15 may be deactivated by reducing power to be supplied to the communication modules 14 and 15 to the minimum value.

A series of processes to be executed until the tablet computer 1 enters the power-saving operation state will be explained with reference to the flowchart of FIG. 4. Processing as shown in the flowchart is started when a graphical user interface (GUI) displayed on the display 3 under a control of, e.g., the OS, is operated by the user, using the touch panel 4, to select setting of the power-saving operation state. The processes as shown in the flowchart are executed by the mode setting module 31.

Firstly, the mode setting module 31 causes a setting image to be displayed by the display 3 (block B101). For example, the setting image includes first GUI part for turning on or off the deep sleep mode, and second GUI part for instructing the tablet computer to enter the power-saving operation state.

The mode setting module 31 awaits completion of the setting, with the setting image displayed (block B102). When the user operates the second GUI part with the touch panel 4, the mode setting module 31 determines that the setting is completed (Yes in block B102). In this case, the mode setting module 31 determines whether the deep sleep (DS) mode is turned on by the second GUI part in the setting image or not (block B103).

If the deep sleep mode is turned on by the second GUI part (Yes in block B103), the mode setting module 31 writes “1” to the register 22b of the RTC 22 (block B104). Thereby, the interrupt function of the RTC 22 is deactivated.

After the block 104, the mode setting module 31 instructs, e.g., the PMIC 20, to stop supplying of power to the wireless communication module 14, to thereby deactivate the wireless communication module 14 (block B105). Furthermore, the mode setting module 31 instructs, e.g., the PMIC 20, to stop supplying of power to the short-distance communication module 15, to thereby to deactivate the short-distance communication module 15 (block B106).

After the block B106, the mode setting module 31 causes the tablet computer 1 to enter the power-saving operation state (block B107). This power-saving operation state is, for example, the above sleep. In this case, the CPU 10 stores in the main memory 12, information or the like written to its register, and the CPU 10 enters an operation state whose power consumption is low, under a control by the PMIC 20. Also, under the control by the PMIC 20, supplying of power to the display 3, the touch panel 4, the speaker 18, the camera module 5, the microphone 19, etc., is stopped. On the other hand, supplying of power to the main memory 12 continues.

In the block B103, if the deep sleep mode is turned off by the second GUI part in the setting image (No in the block B103), the mode setting module 31 writes “0” to the register 22b of the RTC 22 (block B108). Thereby, the interrupt function of the RTC 22 is activated.

After the block B108, the operation of the mode setting module 31 proceeds to the block B107, and the tablet computer 1 enters the power-saving operation state. In this case, neither the wireless communication module 14 nor the short-distance communication module 15 is deactivated. That is, also when the tablet computer 1 enters the power-saving operation state, supplying of power to the communication modules 14 and 15 is continued, thus enabling the tablet computer 1 to receive data transmitted externally.

The processing as shown in the flowchart of FIG. 4 is completed at the block B107.

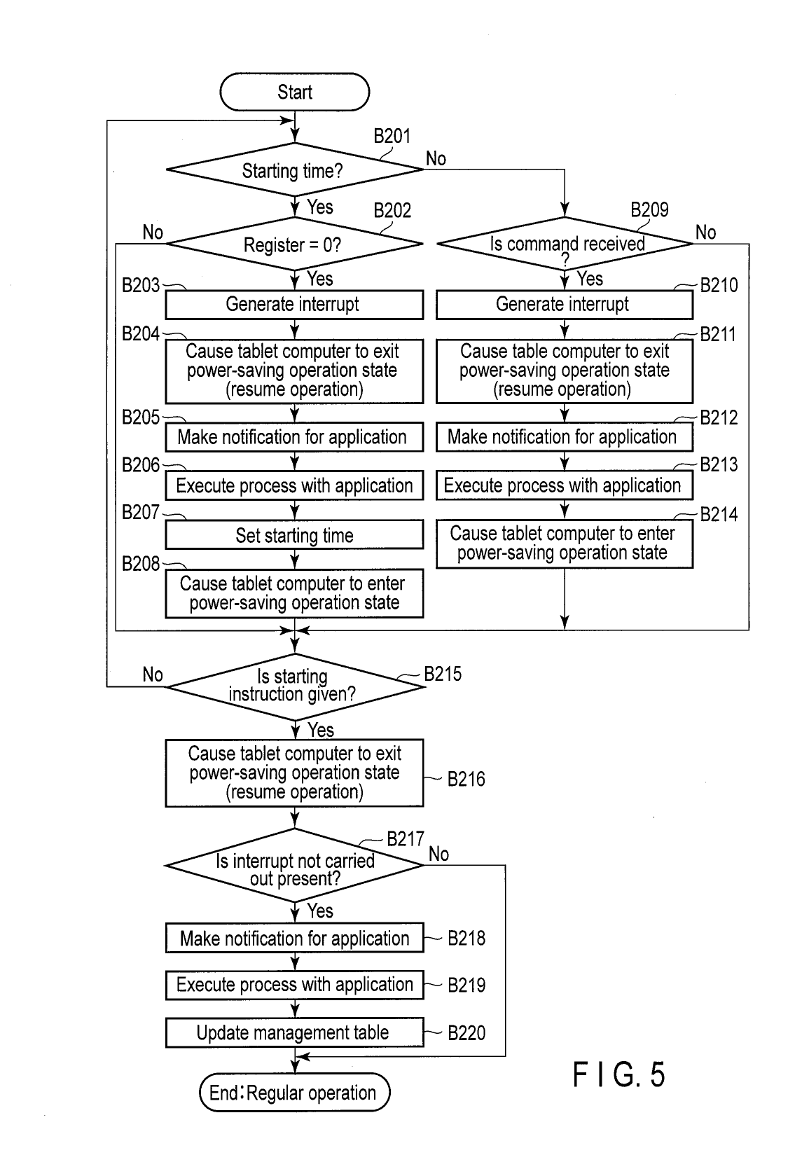

Next, flows of operations of the tablet computer 1 which are to be performed in the cases where it enters the power-saving operation state and also where it exits the power-saving operation state will be explained with reference to the flowchart of FIG. 5.

In the case where the table computer 1 is in the power-saving operation state, the RTC 22 compares time measured by itself with the starting time written to the register 22a. When the starting time is reached (Yes in bock B201), if the register 22b indicates “0” (Yes in Block B202), the RTC 22 generates an interrupt for the CPU 10 (block B203). The PMIC 20 is notified, by the CPU 10, of generation of the interrupt, and the tablet computer 1 resumes operation under a control by the PMIC 20 (block B204). To be more specific, supplying of power for regular operation to the CPU 10 is started, and the CPU 10 reads from the main memory 12, information which is written to its register before it enters the power-saving operation state, and writes the read information to the register. Thereby, the state of the CPU 10 returns to a state in which the CPU 10 is before it enters the power-saving operation state.

After the block B204, the time management module 30 accesses the management table 40, and notifies an application which is identified by AP identification information associated with time (starting time) at which the interrupt is generated, of completion of the starting (block B205). After being notified, the application executes a predetermined process (block B206). The process includes a process in which for example, the application acquires data from an external device such as a server. In this case, the application accesses the external device such as the server, using the wireless communication module 14, and downloads data from the external device.

After the block B206, the time management module 30 updates the starting time indicated by the register 22a (block B207). To be more specific, the time management module 30 deletes from the management table 40, the AP identification information and the starting time associated with the interrupt of the block B203. Furthermore, the time management module 30 reads from the management table 40, a starting time which is the closest to a present date and time, and writes the starting time to the register 22b.

If an application which completes the process of the block B206 re-makes a time setting request, the time management module 30 writes to the management table 40, AP identification information for identifying the application and a starting time, which are included in the time setting request.

After the block B207, the tablet computer 1 re-enters the power-saving operation state under a control by the PMIC 20 (block B208).

In the block B202, if the register 22b indicates “1” (No in block 202), the RTC 22 does not generate an interrupt. That is, if the deep sleep mode is on, an interrupt is not generated by the RTC 22 even when the starting time written to the register 22a is reached. In this case, the blocks B203 to B208 are skipped.

There is a case where the tablet computer 1 is caused to exit the power-saving operation state by a processing request command issued from an external device. To be more specific, while the tablet computer 1 is in the power-saving operation state, when the wireless communication module 14 receives a processing request command from an external device such as a server (Yes in block B209), the wireless communication module 14 generates an interrupt for the CPU 10 (block B210). Furthermore, while the tablet computer 1 is in the power-saving operation state, when the short-distance communication module 15 receives a processing request command from an electronic device located close the short-distance communication module 15 (Yes in block B209), the short-distance communication module 15 generates an interrupt for the CPU 10 (block B210). In both the above cases, the CPU 10 notifies the PMIC 20 of generation of the interrupt, and the tablet computer 1 resumes operation under a control by the PMIC 20 as in the block B204 (block B211).

The processing request command includes, e.g., AP identification information. The time management module 30 notifies an application identified by the AP identification information of completion of the starting (block B212). When being notified, the application executes a predetermined process (block B213). The process includes a process to be executed by the application for acquiring data from an external device. In the case where the interrupt of the block B210 is generated by the wireless communication module 14, the application accesses the external device such as a server, using the wireless communication module 14, and downloads the data from the external device. On the other hand, in the case where the interrupt of the block B210 is generated by the short-distance communication module 15, the application accesses the external device such as an electronic device located close to the tablet computer 1, using the short-distance communication module 15, and downloads data from the external device. The process to be executed may be written to the processing request command, and is executed by the application in the block B213.

After the block B213, the tablet computer 1 re-enters the power-saving operation state under a control by the PMIC 20 (block B214).

In the block B209, if the wireless communication module 14 or the short-distance communication module 15 does not receive a processing request command (No in block B209), the blocks B210 to B214 are skipped. If the deep sleep mode is on, since the wireless communication module 14 and the short-distance communication module 15 are deactivated, they cannot receive a processing request command from the external device even if processing request command is transmitted therefrom. Therefore, if the deep sleep mode is on, the processes of the blocks B210 to B214 are not executed.

The blocks B201-3214 are repeated until a starting instruction is input to the tablet computer 1 by, e.g., operating a power-supply button (No in block B215).

When the starting instruction is input (Yes in block B215), the tablet computer 1 resumes operation under a control by the PMIC 20 (block B216). At this time, the time management module 30 determines whether or not a starting time which is past time, i.e., which is prior to a present date and time, is written to the management table 40 (block B217). An interrupt at such a starting time is not carried out since the deep sleep mode is on.

If an interrupt not carried out is present (Yes in block B217), the time management module 30 notifies an application identified by AP identification information associated with the starting time of completion of the starting (block B218). When being notified, the application executes a process which should have been executed at the starting time (block B219). It should be noted that if a plurality of starting times which are past times, i.e., which are prior to a present date and time, are written to the management table 40, the applications execute the processes of the blocks B218 and B219 in turn from an application identified by AP identification information associated with the earliest one of the starting times to an application identified by AP identification information associated with the latest one of the starting times.

After the block B219, the time management module 30 updates the management table 40 (block B220). To be more specific, the time management module 30 deletes from the management table 40, AP identification information and starting time which are referred to in the processes of the Blocks 218 and 219. If an application which completes the process of the block B219 re-makes a time setting request, the time management module 30 writes to the management table 40, AP identification information for identifying the application and a starting time, which are included in the time setting request.

After the block 220, the tablet computer 1 enters a regular operation state. Also, in the block B217, if an interrupt not carried out is not present (No in block B217), the tablet computer 1 skips the blocks B218 to B220 and enters the regular operation state.

As explained above, the tablet computer 1 according to the embodiment has the deep sleep mode in which the RTC 22 inhibits the tablet computer 1 from exiting the power-saving operation state due to an interrupt. Thus, the resume of the tablet computer 1 in the power-saving operation state is restricted by turning on the deep sleep mode, and the power consumption of the battery 21 can be reduced.

Also, if the deep sleep mode is on, the tablet computer 1 does not resume operation even when a starting request command is transmitted from the external device. Thereby, the power consumption of the battery 21 can be further reduced.

Furthermore, if the deep sleep mode is on, as a result of which the tablet computer 1 does not resume operation even when the starting time is reached while being in the power-saving operation state, the tablet computer 1 executes a process which should have been executed at the starting time, immediately after resuming operation next time. This can minimize an influence of non-execution of the above process at the starting time.

### Modification

Some modifications will be explained.

With respect to the above embodiment, the tablet computer is explained above as an example of the electronic device. However, the same structure as in the above embodiment can be applied to various electronic devices such as a notebook personal computer, a smart phone, a PDA and a digital camera.

With respect to the above embodiment, the power-saving operation state explained above by way of example is a sleep corresponding to S3 class. However, the power-saving operation state may be another kind of power-saving operation state such as hibernation.

The electronic device may include a communication module configured to communicate with the external device through wire. In this case, the communication module may be added to elements to be deactivated when the deep sleep mode is turned off.

With respect to the above embodiment, it is explained above by way of example that a process which is executed by the electronic device when the electronic device is caused to exit the power-saving operation state due to an interrupt generated by the RTC is acquisition of data by an application. However, the above process may be another process to be executed by the application or a process to be executed by the OS.

With respect to the above embodiment, the above explanation of the starting time is given on the assumption that the RTC can store a single stating time. However, the electronic device may include an RTC which can store two or more starting times.

With respect to the above embodiment, it is explained above by way of example that the deep sleep mode is turned on or off with the setting image, and the electronic device is instructed to enter the power-saving operation state. These operations, however, may be performed by another method. For example, the electronic device may be set to automatically enter the power-saving operation state when the predetermined time is reached or when the touch panel 4 is not operated for a predetermined time period.

Furthermore, the mode setting module may display the setting image including the first GUI part and the second GUI part on the display, when the remaining amount of the battery lowers to a predetermined reference value.

The blocks as shown in the flowcharts of FIGS. 4 and 5 may be interchanged as appropriate. For example, the processes of the blocks B104 to B106 may be executed in an arbitrary order.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a power supply configured to supply power;
a processor configured to operate with the power supplied by the power supply, and capable of entering a power-saving operation state in which consumption of the power is lower than that in a regular operation state;
a mode setting controller configured to turn on or off a mode in which the processor is inhibited from exiting the power-saving operation state due to an interrupt; and
a clock configured to generate the interrupt for causing the processor to exit the power-saving operation state, when the mode is off, when first time is reached while the processor is in the power-saving operation state, and not to generate the interrupt, when the mode is on, even when the first time is reached while the processor is in the power-saving operation state.

2. The electronic device of claim 1, wherein:
the clock comprises a register configured to store one of first identification information and second identification information;
the clock is configured to generate the interrupt when the first time is reached, when the register stores the first identification information, and not to generate the interrupt even when the first time is reached, when the register stores the second identification information; and
the mode setting controller is configured to turn off the mode by causing the register to store the first identification information, and to turn on the mode by causing the register to store the second identification information.

3. The electronic device of claim 1, further comprising a communication controller configured to communicate with an external device,
wherein the communication controller is configured to generate the interrupt, when the mode is off, when receiving data transmitted from the external device while the processor is in the power-saving operation state, and not to generate the interrupt, when the mode is on, even when the data is transmitted from the external device.

4. The electronic device of claim 1, further comprising:
a display configured to display an image; and
an operation controller configured to operate the image displayed by the display,
wherein the mode setting controller is configured to cause a setting image for turning on or off the mode to be displayed by the display, and turns on or off the mode in accordance with an operation by the operation controller on the setting image.

5. The electronic device of claim 4, further comprising a battery configured to supply power for operating the electronic device,
wherein the mode setting controller is configured to cause the setting image to be displayed by the display when a remaining amount of the battery reaches a reference value.

6. The electronic device of claim 1, wherein the processor is configured to execute a first process regarding a specific application, when exiting the power-saving operation state by the interrupt.

7. The electronic device of claim 6, further comprising a communication controller configured to communicate with an external device,
wherein the first process includes a process for receiving data regarding the application using the communication controller.

8. The electronic device of claim 6, wherein the processor is configured to execute the first process after being caused to exit the power-saving operation state, when the first time is reached while the processor is in the power-saving operation state and the mode is on.

9. A control method for an electronic device which comprises a power supply configured to supply power, a processor configured to operate with the power supplied by the power supply, and a clock having a function of generating an interrupt for the processor, the method comprising:
turning on or off a mode in which the processor is inhibited from exiting a power-saving operation state in which consumption of the power supplied by the power supply is lower than that in a regular operation state;
causing the processor to enter the power-saving operation state;
generating the interrupt, by the clock, for causing the processor to exit the power-saving operation state, when first time is reached while the processor is in the power-saving operation state, except for a case where the mode is on; and
causing the processor to exit the power-saving operation state, when the interrupt is generated.

10. A non-transitory computer-readable storage medium having stored thereon a computer program which is executable by a computer which comprises a power supply configured to supply power, a processor configured to operate with the power supplied by the power supply, and a clock having a function of generating an interrupt for the processor, the computer program controlling the computer to perform functions of:
turning on or off a mode in which the processor is inhibited from exiting a power-saving operation state in which consumption of the power supplied by the power supply is lower than that in a regular operation state;
causing the processor to enter the power-saving operation state; and
causing the processor to exit the power-saving operation state due to the interrupt which is generated by the clock when first time is reached while the processor is in the power-saving operation state, except for a case where the mode is on.
